(19) United States
(12) Patent Application Publication
(10) Pub. No.: US 2026/0153846 A1
(43) Pub. Date: Jun. 4, 2026

(54) PREDICTIVE FOUNDATION EMBEDMENT

(71) Applicant: Ojjo, Inc., San Rafael, CA (US)

(72) Inventors: Steven Kraft, Albany, CA (US); Russdon David Angold, American Canyon, CA (US)

(21) Appl. No.: 19/389,386

(22) Filed: Nov. 14, 2025

Related U.S. Application Data
(60) Provisional application No. 63/727,770, filed on Dec. 4, 2024.

(51) Int. Cl. G05B 19/042

(52) U.S. Cl. CPC G05B 19/042; G05B 2219/23123; G05B 2219/25138

(57) ABSTRACT

A machine for driving foundation components includes a base machine, a rotary driver movably attached to an adjustable mast and controllable to drive a foundation component into underlying ground, a storage device storing program code for predictive foundation component embedment, and a programmable controller communicatively coupled to the storage device and the rotary driver. Executing the program code for predictive foundation component embedment causes the programmable controller to: control the rotatory driver to drive the foundation component into underlying ground, acquire substantially real-time rotary driver related data from the rotary driver while the rotary driver is driving the foundation component into underlying ground, and use the acquired substantially real-time rotary driver related data and the program code for predictive foundation component embedment to predict whether the foundation component has been embedded into underlying ground to provide sufficient resistance to pull out of the foundation component.

### RELATED APPLICATIONS

This application claims the benefit of U.S. Provisional Ser. No. 63/727,770, filed Dec. 4, 2024, the entire contents of which are incorporated herein by reference.

### TECHNICAL FIELD

This disclosure relates generally to systems, methods, devices, and machines for predicting whether a foundation component has been successfully embedded in the ground.

### BACKGROUND

As the price of solar has dropped relative to fossil fuel-based energy sources, single-axis solar trackers are becoming the preferred form factor for so-called utility-scale solar arrays. Utility-scale arrays may span a few megawatts of capacity up to hundreds of kilowatts. Single-axis trackers are configured as North-South oriented single or double rows of solar panels attached to a torque tube. The torque tube is attached to a motor or other drive mechanism that slowly rotates all the attached panels at once, so they move from East-facing to West-facing to follow the sun's daily movement through the sky.

Tracker companies usually supply all the components that attach to the torque tube (e.g., bearings, motors or drive assemblies, dampers and module brackets), but rely on other companies to supply the foundation that anchors their systems to the Earth using a standard interface.

When installing a solar tracker foundation in the ground, soil conditions at subsurface the solar tracker foundation installation locations can vary. In particular, for a given utility-scale solar tracker array that can span a large area, subsurface soil conditions can vary considerably on a localized basis. For example, one foundation for a utility-scale solar tracker may be embedded in the ground at a first location having relatively soft subsurface soil conditions, while another foundation for the utility-scale solar tracker may be embedded in the ground at a second, different location having relatively hard subsurface soil conditions.

Such different subsurface soil conditions can impact whether a foundation component is successfully embedded into the ground with sufficient resistance to pullout. However, after terminating the foundation component embedment, manually checking whether every embedded foundation component has been successfully embedded into the ground with sufficient resistance to pullout can be costly and impractical given the scale of many utility solar trackers. Moreover, if and when inadequacy of a foundation component embedment is manually discerned after terminating the foundation component embedment, post-embedment remediation of the adequacy of foundation component embedment can be inefficient, for instance, necessitating return and setup of hardware and resources back at the location where the foundation component was previously installed.

### SUMMARY

This disclosure relates generally to systems, methods, devices, and machines for predicting whether a foundation component has been successfully embedded in the ground. More specifically, embodiments disclosed herein can input substantially real-time data, from one or more sensory nodes at a machine while the machine is driving a first foundation component into the ground, into a predictive foundation embedment module (e.g., while the machine is driving the first foundation component into the ground). This predictive foundation embedment module can then use this substantially real-time data along with one or more past foundation embedment data correlations, which relate to one or more different and prior foundation component embedment, to predict whether the first foundation component has been successfully embedded by the machine into the ground. This can enable an automated prediction as to whether the first foundation component has been successfully embedded in the ground at a time when the machine that drives the first foundation component into the ground and when that machine is still present at that location of the first foundation component embedment. As such, in instances where the predictive foundation embedment module outputs a prediction that the first foundation component has been unsuccessfully embedded by the machine into the ground, a remediation indication can be output while the machine is still present at the location of what is predicted to be the unsuccessful embedment of the first foundation component embedment.

This can help to increase efficiency and reduce costs associated with solar tracker installation. For example, this can help to reduce or eliminate instances of post-embedment remediation of the foundation component which would otherwise necessitate return and setup of hardware and resources back at the location where the foundation component was previously, unsuccessfully installed. Embodiments disclosed herein instead can leverage substantially real-time data relating to the foundation component embedment (e.g., rotary driving) relative to one or more past foundation component embedment data correlations, which relate to one or more different and prior foundation component embedments, to predict whether the foundation component being driven into the ground has been successfully embedded in the ground to provide sufficient resistance to pull out from the ground of that foundation component.

Certain embodiments disclosed herein can feed substantially real-time rotary driver related data from one or more sensory nodes at the machine during the embedment operation to the predictive foundation embedment module accessible by a controller at the machine to make a determination of whether the present foundation component embedment operation was successful. If determined to be unsuccessful, some embodiments disclosed herein can take one or more remediation related actions with respect to that foundation component predicted to have been embedded unsuccessfully (e.g., with respect to that foundation component predicted to have been embedded to provide insufficient resistance to pull out of the foundation component). For example, such embodiments can provide a corresponding indication (e.g., a visual indication) at a user interface at, or in communication with, the machine as to the predicted unsuccessful embedment of that foundation component, can further execute one or more embedment parameters at the rotary driver to further drive the foundation component to help mitigate the insufficient foundation component embedment, and/or can log/save a location (e.g., GPS location) of that foundation component predicted to have been unsuccessfully embedded to track and flag such foundation component for later remediation action.

One embodiment disclosed herein is a control system for a solar tracker foundation component installation machine. This control system includes a rotary driver, a storage device, and a programmable processor. The rotary driver is controllable to drive a first solar tracker foundation component into underlying ground. The storage device stores program code for predictive foundation component embedment. The programmable controller is communicatively coupled to the storage device and the rotary driver. Executing the program code for predictive foundation component embedment causes the programmable controller to: control the rotatory driver to drive the first solar tracker foundation component into underlying ground, acquire substantially real-time rotary driver related data from the rotary driver while the rotary driver is driving the first solar tracker foundation component into underlying ground, and input the acquired substantially real-time rotary driver related data into the program code for predictive foundation component embedment to predict whether the first solar tracker foundation component has been embedded into underlying ground to provide sufficient resistance to pull out of the first solar tracker foundation component.

In a further embodiment of this system, the acquired substantially real-time rotary driver related data from the rotary driver includes substantially real-time rotary driver torque related data while the rotary driver is driving the first solar tracker foundation component into underlying ground. For example, where the rotary driver is an electrically actuated rotary driver, the acquired substantially real-time rotary driver torque related data can include at least one electrical current measurement across a drive motor of the rotary driver while the rotary driver is driving the first solar tracker foundation component into underlying ground. As another example, where the rotary driver is a hydraulically actuated rotary driver, the acquired substantially real-time rotary driver torque related data can include at least one fluid pressure measurement across the rotary driver while the rotary driver is driving the first solar tracker foundation component into underlying ground. In other embodiments, the acquired substantially real-time rotary driver related data from the rotary driver includes substantially real-time rotary driver torque related data such as data relating to elapsed time during a foundation component drive operation and/or whether or not a drill assist is provided to the rotary driver during a foundation component drive operation.

In a further embodiment of this system, the program code for predictive foundation component embedment includes a machine learning code component that has been trained with pre-existing solar tracker foundation installation data. This pre-existing solar tracker foundation installation data used to train the machine learning code component includes: a first training set of rotary driver torque related data corresponding to one or more prior solar tracker foundation component installations determined to provide sufficient embedment resistance to foundation component pull out, and a second training set of rotary driver torque related data corresponding to one or more prior solar tracker foundation component installations determined to provide insufficient embedment resistance to foundation component pull out.

In a further embodiment of this system, when the acquired substantially real-time rotary driver related data and the program code for predictive foundation component embedment are used to predict that the first solar tracker foundation component has been embedded into underlying ground to provide insufficient resistance to pull out of the first solar tracker foundation component, executing the program code for predictive foundation component embedment further causes the programmable controller to save a location of the first solar tracker foundation component. In addition, for certain such embodiments, executing the program code for predictive foundation component embedment can further cause the programmable controller to generate a report indicating the location of the first solar tracker foundation component predicted to have been embedded into underlying ground to provide insufficient resistance to pull out.

In a further embodiment of this system, the system additionally includes a user interface communicatively coupled to the programmable controller. When the acquired substantially real-time rotary driver related data and the program code for predictive foundation component embedment are used to predict that the first solar tracker foundation component has been embedded into underlying ground to provide insufficient resistance to pull out of the first solar tracker foundation component, the program code for predictive foundation component embedment can be executed to cause the programmable controller to output at the user interface an indication as to predicted insufficient resistance to pull out relating to the first solar tracker foundation component.

In a further embodiment of this system, when the acquired substantially real-time rotary driver related data and the program code for predictive foundation component embedment are used to predict that the first solar tracker foundation component has been embedded into underlying ground to provide insufficient resistance to pull out of the first solar tracker foundation component, the program code for predictive foundation component embedment can be executed to cause the programmable controller to determine whether the first solar tracker foundation component has additional length for further embedding the first solar tracker foundation component into the underlying ground. In one such example, when the program code for predictive foundation component embedment is executed to cause the programmable controller to determine that the first solar tracker foundation component has additional length for further embedding the first solar tracker foundation component into the underlying ground, the program code for predictive foundation component embedment can be executed to automatically cause the programmable controller to further drive the first solar tracker foundation component into the underlying ground.

Another embodiment includes a machine for driving foundation components. This machine includes a base machine, an adjustable mast attached to the base machine, a rotary driver movably attached to the mast and controllable to drive a foundation component into underlying ground, a storage device storing program code for predictive foundation component embedment, and a programmable controller communicatively coupled at least to the storage device and the rotary driver. Executing the program code for predictive foundation component embedment causes the programmable controller to: control the rotatory driver to drive the first solar tracker foundation component into underlying ground, acquire substantially real-time rotary driver related data from the rotary driver while the rotary driver is driving the first solar tracker foundation component into underlying ground, and use the acquired substantially real-time rotary driver related data and the program code for predictive foundation component embedment to predict whether the first solar tracker foundation component has been embedded into underlying ground to provide sufficient resistance to pull out of the first solar tracker foundation component.

In a further embodiment of this machine, the acquired substantially real-time rotary driver related data from the rotary driver includes substantially real-time rotary driver torque related data while the rotary driver is driving the first solar tracker foundation component into underlying ground.

In a further embodiment of this machine, the program code for predictive foundation component embedment includes a machine learning code component that has been trained with pre-existing solar tracker foundation installation data. This pre-existing solar tracker foundation installation data used to train the machine learning code component includes: a first training set of rotary driver torque related data corresponding to one or more prior solar tracker foundation component installations determined to provide sufficient embedment resistance to foundation component pull out, and a second training set of rotary driver torque related data corresponding to one or more prior solar tracker foundation component installations determined to provide insufficient embedment resistance to foundation component pull out.

In a further embodiment of this machine, when the acquired substantially real-time rotary driver related data and the program code for predictive foundation component embedment are used to predict that the first solar tracker foundation component has been embedded into underlying ground to provide insufficient resistance to pull out of the first solar tracker foundation component, executing the program code for predictive foundation component embedment can cause the programmable controller to save a location of the first solar tracker foundation component. In some such examples, executing the program code for predictive foundation component embedment further causes the programmable controller to generate a report indicating the location of the first solar tracker foundation component predicted to have been embedded into underlying ground to provide insufficient resistance to pull out.

In a further embodiment of this machine, the machine additionally includes a user interface communicatively coupled to the programmable controller. When the acquired substantially real-time rotary driver related data and the program code for predictive foundation component embedment are used to predict that the first solar tracker foundation component has been embedded into underlying ground to provide insufficient resistance to pull out of the first solar tracker foundation component, executing the program code for predictive foundation component embedment causes the programmable controller to output at the user interface an indication as to predicted insufficient resistance to pull out relating to the first solar tracker foundation component.

In a further embodiment of this machine, when the acquired substantially real-time rotary driver related data and the program code for predictive foundation component embedment are used to predict that the first solar tracker foundation component has been embedded into underlying ground to provide insufficient resistance to pull out of the first solar tracker foundation component, executing the program code for predictive foundation component embedment causes the programmable controller to determine whether the first solar tracker foundation component has additional length for further embedding the first solar tracker foundation component into the underlying ground. For some such examples, the program code for predictive foundation component embedment is executable to automatically cause the programmable controller to further drive the first solar tracker foundation component into the underlying ground based on the determined additional length for further embedding.

An additional embodiment include a method of predicting adequacy of installation of a solar tracker foundation component. This method includes the steps of: controlling a rotary driver of a foundation component driving machine to embed a first solar tracker foundation component into underlying ground; acquiring substantially real-time rotary driver torque related data from the rotary driver while the rotary driver is driving the first solar tracker foundation component into underlying ground; and predicting whether the first solar tracker foundation component has been embedded into underlying ground to provide sufficient resistance to pull out of the first solar tracker foundation component by inputting the acquired substantially real-time rotary driver torque related data into program code for predictive foundation component embedment.

In a further embodiment of this method, the method additionally includes the steps of: when the first solar tracker foundation component is predicted to have been embedded into underlying ground to provide insufficient resistance to pull out of the first solar tracker foundation component, saving a location of the first solar tracker foundation component; and generating a report indicating the location of the first solar tracker foundation component predicted to have been embedded into underlying ground to provide insufficient resistance to pull out.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 illustrates a perspective view of a screw anchor foundation component that can be driven by the machine to embed the screw anchor in underlying ground according to various embodiments of the invention.

FIG. 2 is an exemplary EARTH TRUSS foundation in accordance with various embodiments of the invention.

FIGS. 3A-3C illustrate a foundation component driving machine in accordance with various embodiments of the invention. FIG. 3A is a perspective view of this foundation component driving machine embodiment, and FIGS. 3B and 3C show a portion of the foundation component driving machine's mast oriented at different driving angles.

FIG. 4 is an isolation view of the mast and attached components of the embodiment of the foundation component driving machine of FIG. 3A.

FIG. 5 is an exemplary control circuit usable with the various embodiments of the invention.

FIG. 6 is a block diagram showing an exemplary control system for predicting whether a driven foundation component has been sufficiently embedded in the ground according to various embodiments of the invention.

FIG. 7 is a flow diagram showing steps of a method for generating a predictive foundation component embedment algorithm according to various embodiments of the invention.

FIGS. 8A and 8B show schematic diagrams illustrating exemplary use of training data sets to determine correlations to past sufficient (e.g., FIG. 8A) and insufficient (e.g., FIG. 8B) foundation component embedments according to various embodiments of the invention.

FIG. 9 is a block diagram illustrating use of training data sets and a machine learning algorithm to generate a predictive foundation component embedment algorithm that includes correlations to past sufficient and insufficient foundation component embedments according to various embodiments of the invention.

FIG. 10 is a block diagram showing an exemplary control system architecture for a foundation component driving machine according to various embodiments of the invention.

FIG. 11 is a flow diagram showing steps of a method for predicting adequacy of installation of a solar tracker foundation component according to various embodiments of the invention.

### DETAILED DESCRIPTION

The invention will now be described in the context of the drawing figures where like elements are referred to with like designations. This description is intended to convey a thorough understanding of the embodiments described by providing a number of specific embodiments and details involving methods, machines and systems for embedding foundation components, such as foundation components for single-axis solar trackers. It should be appreciated, however, that the present invention is not limited to these specific embodiments and details, which are exemplary only. Although the various embodiments of the invention may be especially useful for predicting adequacy of installation of a solar tracker foundation component during embedment of that solar tracker foundation component at a single-axis solar tracker foundation embedment location, embodiments herein may also be useful for controlling and improving the embedment process for foundation components for a variety of numerous other structures. It should be further understood that one possessing ordinary skill in the art in light of known systems and methods, would appreciate the use of the invention for its intended purposes and benefits in any number of alternative embodiments, depending upon specific design and other needs.

Embodiments disclosed herein can predict adequacy of installation of a foundation component during embedment of that foundation component. In particular, embodiments disclosed herein can input substantially real-time data, from one or more sensory nodes at an embedment machine while that machine is driving the foundation component into the ground, into a predictive foundation embedment module. For example, such embodiments can feed substantially real-time rotary driver related data (e.g., current at the rotary driver; pressure at the rotary driver; data relating to elapsed time during a foundation component drive operation; and/or whether or not a drill assist is provided to the rotary driver during a foundation component drive operation) from one or more sensory nodes at the machine during the embedment operation to the predictive foundation embedment module accessible by a controller at the machine. This predictive foundation embedment module can then use this substantially real-time data along with one or more past foundation embedment data correlations, which relate to one or more different and prior foundation component embedment, to predict whether the foundation component has been successfully embedded by the machine into the ground. This can enable an automated prediction as to whether the foundation component has been embedded in the ground to provide sufficient resistance to pull out of that foundation component at a time when the machine that drives the first foundation component into the ground is still present at that location of the foundation component embedment. As such, in instances where the predictive foundation embedment module outputs a prediction that the foundation component has been unsuccessfully embedded by the machine into the ground, a remediation indication can be generated while the machine is still present at the location of what is predicted to be the unsuccessful embedment of the foundation component embedment.

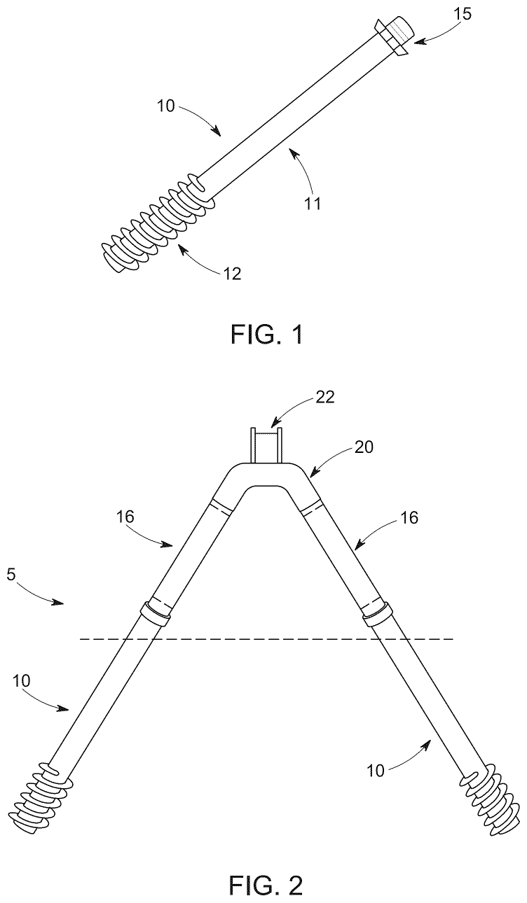

FIG. 1 illustrates a perspective view of an embodiment of a foundation component 10 that can be driven by a foundation component driving machine to embed the foundation component 10 in underlying ground, according to various embodiments of the invention. Such foundation component 10 can thus be referred to a foundation anchor component to which one or more above ground support legs can be attached. The illustrated embodiment here shows the foundation component 10 as a ground screw anchor type foundation component configured to be embedded at least partially in the ground, though other examples of foundation components 10 can be used, such as a helical pile type anchor foundation component or blade pile type anchor foundation component that is configured to be embedded at least partially in the ground.

Foundation component 10 of the screw anchor type can consist of a hollow, substantially uniform diameter shaft 11 that is open at both ends with external threads 12 at one end and a driving collar 15 at the other. In various embodiments, threads 12 may have a uniform diameter profile at the outer diameter of the base shaft of the screw anchor. The length of foundation component 10 may be variable depending on the desired depth of embedment (e.g., 1-2 meters into the underlying ground). In the context of foundations for single-axis trackers and other axial solar arrays, embedment depth may be dictated by subsurface soil type, grade of land, torque tube height, among other factors. The inside diameter of the shaft may be between two and half and three inches and the thickness on the order of a few millimeters. It may be formed from galvanized alloy steel or other suitable material. In some cases, it may be coated with one or more additional anti-corrosion coatings such as fusion bonded epoxy, polyurethane, and acrylic among others. Driving collar 15 may be a separate cast structure welded on to the upper end of shaft 11 or, alternatively, may be stamped or otherwise formed in the upper end. Threads 12 may be welded to the outside of shaft 11 at the lower end, may be attached with bent tabs or, in some cases may even be stamped into the lower end. The threads enable screw anchor type foundation component 10 to be driven into, and at least partially embedded at, supporting ground with a combination of torque and downforce. The open end allows a drill or other tool to be extended through foundation component 10 while the anchor is being driven into the ground to enable it to go through dense soil, rocks or other strata that might refuse the anchor itself.

The Applicant of this disclosure has developed a foundation system for axial solar arrays that reduces the amount of steel required to support an array relative to conventional H-piles and can include a pair of foundation components 10, such as a pair of screw anchors such as shown at FIG. 1. One variant of this foundation system that is particularly well-suited for supporting single-axis trackers and known commercially as EARTH TRUSS, is shown in FIG. 2. The EARTH TRUSS system 5 shown in FIG. 2 consists of a pair of adjacent screw anchor type foundation components 10 that have been driven into supporting ground at angles to one another on the East and West sides of an intended North-South line of a tracker row. Though it is to be noted embodiments within the scope of this disclose could likewise utilize other types of solar tracker foundation components other than a screw anchor type, for instance, such as a pair of helical pile or blade pile type foundation components 10. Once foundation components 10 have been driven to their target embedment depth, an upper leg 16 is attached to each foundation component 10 via driving collar 15. In various embodiments, each upper leg 16 may be temporarily sleeved over one of the collars 15 while an adapter or truss cap 20 is fitted into the opposing ends of each upper leg 16 to complete the foundation. In various embodiments, the foundation component driving machine may include a jig or other device that orients the adapter or truss cap so that it is level and aligned with a laser line to be at the at the same Y (East-West) and Z (up-down) position as every other adapter in the current row. In various embodiments, once the adapter or truss cap 20 has been properly aligned, upper legs 16 may be crimped at each end, that is, at the areas of overlap with foundation components 10 and with truss cap or adapter 20, thereby forming a rigid A-frame structure. In various embodiments, assembling the EARTH TRUSS at the time the pair of foundation components 10 (e.g., pair of screw anchors) are driven will obviate the need for later alignment steps, such as when the solar tracker components are later installed at the foundation.

Exemplary adapter 20 shown at FIG. 2 consists of a pair of open connecting portions that, in this example, are received within respective upper legs 16, and a H-pile like mounting portion 22 that extends upward and approximates the web and flange geometry of a standard W6x9 or W6x12 H-pile. With this geometry, adapter 20 may support any tracker system that is designed to attach to an H-pile. It should be appreciated, however, that in other embodiments adapter 20 may take on a different geometry that includes an integrated bearing portion and/or that is optimized to integrate with one or more specific tracker systems. The various systems, methods and machines according to the various embodiments of the invention are agnostic as to which particular adapter is used. Regardless of which is used, in various embodiments the machine may provide a jig, bracket or other guide to hold the adapter at the desired orientation so that the EARTH TRUSS can be constructed in a fast, precise and repeatable manner using acquired subsurface condition data.

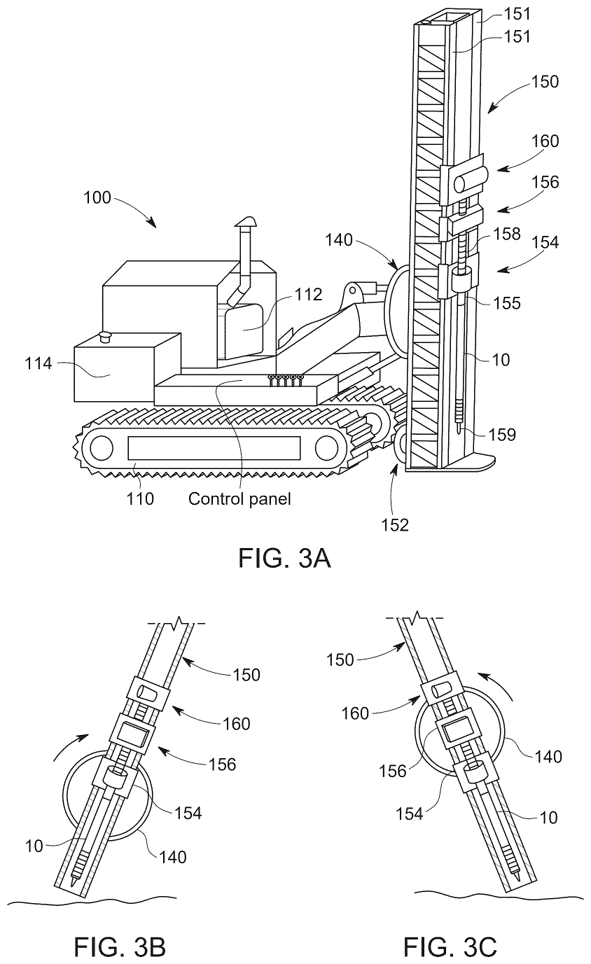

FIGS. 3A-3C illustrate a foundation component driving machine 100 in accordance with various embodiments of the invention. FIG. 3A is a perspective view of this foundation component driving machine 100, and FIGS. 3B and 3C show a portion of the foundation component driving machine's mast 150 oriented at different driving angles. Machine 100 can be configured to predict adequacy of installation of a foundation component during embedment of that foundation component. To do so, embodiments of machine 100 can input substantially real-time data, from one or more sensory nodes at the machine 100, into a predictive foundation embedment module while machine 100 is driving the foundation component into the ground. This can include machine 100 feeding substantially real-time rotary driver related data (e.g., current at the rotary driver; pressure at the rotary driver; data relating to elapsed time during a foundation component drive operation; and/or whether or not a drill assist is provided to the rotary driver during a foundation component drive operation) from one or more sensory nodes at machine 100 during the embedment operation to the predictive foundation embedment module accessible by a controller at the machine 100. This predictive foundation embedment module can then use this substantially real-time rotary driver related data along with one or more past foundation embedment data correlations (which relate to one or more different and prior foundation component embedments) to predict whether the foundation component has been embedded by the machine into the ground to provide sufficient resistance to pull out of that foundation component.

As one example, foundation component driving machine 100 can be a type manufactured by the applicant of this disclosure and known commercially as the TRUSS DRIVER according to various exemplary embodiments of the invention. The TRUSS DRIVER can be used to drive adjacent foundation anchor components (e.g., screw anchor pairs) into underlying ground along the tracker row according to one or more installation parameters. The machine 10 can also be configured to support the adapter, bearing adapter or other apex hardware while upper legs are attached to the ground embedded foundation components. As shown, machine 100 is built on tracked chassis 110 with diesel motor 112 and a hydraulic drive system. It should be appreciated that other embodiments within the scope of this disclosure can include versions of the machine that are electrically powered such that an electrically driven rotary drive motor is used in place of the hydraulic drive system. Such modifications are within the spirit and scope of the invention. Also, it should be appreciated that machine 100 could instead ride on tires, on a combination of tires and tracks, on a floating barge, on rails or on another movable platform.

Machine 100 supports articulating mast 150. In the figure, mast 150 is shown as an elongated ladder-like truss structure extending approximately 15-20 feet in the long direction. It is connected to machine 100 by one or more hydraulic actuators. In various embodiments, articulating mast 150 can move through an arc in at least one plane extending from the front to the back of the machine that spans approximately 90-degrees to allow mast 150 to go from a stowed position where the mast is substantially parallel to the machine's tracks to an in-use position where the mast is substantially perpendicular to them. Therefore, when mast 150 is in the stowed position, its height will be minimized, whereas when mast 150 is in-use, it will extend far above machine 100. In various embodiments, rotator 140 is positioned in front of the one or more actuators connecting mast 150 to machine 100 so that mast 150 may rotate through a range of angles about a point of rotation (e.g., plus or minus 35-degrees from plumb) so that foundation anchor components (e.g., screw anchors) may be driven into the ground at a range of angles. This also decouples the driving angle from the left to right slope of the ground under the machine, allowing it to compensate for uneven terrain.

In various embodiments, in addition to rotating in plane, articulating mast 150 may move with respect to machine 100 so that it can self-level, adjust its pitch, and yaw and move in the X, Y and Z-directions (where X is North-South, Y is East-West, and Z is vertical) without moving the machine. This may be accomplished with additional actuators or slides that move an intermediate frame that supports rotator 140 and that is positioned between the rotator and machine 100. The components of machine 100 used to drive foundation components, such as screw anchors, as opposed to positioning the mast, are mounted on mast 150. Mast 150 includes parallel tracks 151 that define the plane that those components move in. Therefore, the mast's orientation dictates the vector or driving axis that screw anchors are driven along. Alternatively, mast components may travel on wheels retained on a track running along the mast.

As shown, the driving components include rotary driver 154 with chuck 155 that connects to driving collar 15 of screw anchor 10. Some embodiments of the machine 100 can also include a tool driver 156, located above the rotary driver 154. In various embodiments, rotary driver 154 may be powered by hydraulics, in which case machine 100 can include a sensor to detect hydraulic pressure (e.g., at the rotary driver 154), or by electric current, in which case machine 100 can include a sensor to detect electrical current (e.g., across the electric motor of the rotary driver 154). Similarly, tool driver 156 may be powered by hydraulics, compressed air or electric current and can likewise include one or more related sensor(s) at machine 100 to detect substantially real-time tool driver related data during foundation component embedment (e.g., which could be used in addition to rotary driver related data as input into the predictive embedment module). In various embodiments, tool driver 156 is a hydraulic drifter that drives a tool consisting of shaft 158 and bit or tip 159 that extends along mast 150, passing through rotary driver 154, chuck 155 and the center of foundation component 10. In various embodiments, and as shown in the figures, rotary driver 154 and tool driver 156 may be oriented concentrically on mast 150 in the direction of tracks 151 so that shaft 158 can pass through rotary driver 154 while it is driving a foundation component (e.g., screw anchor). In this manner, the tool tip 159 may operate ahead of the foundation component's tip, projecting out of its open, lower end. In various embodiments, rotary driver 154 is loaded by sleeving a foundation component over tip 159 and shaft 158 until it reaches chuck 155. Alternatively, tool driver 156 may be withdrawn up mast 150 until shaft 158 and tip 159 are substantially out of the way. Then, mast 150 can be moved to the desired driving vector. In some embodiments, this may comprise aligning the mast and then rotating it in the aligned plane. In other embodiments, the entire mast may be moved so that the point of rotation is oriented somewhere along the driving axis. This will ensure that the driven foundation component 10 points at the desired work point. In various embodiments, an operator may then adjust a slide control for the mast to lower the mast foot 161 to the point where at least a portion of it reaches the ground.

Machine 100 causes the foundation component to be driven to a desired embedment depth, and when the operation is complete, rotary driver 154 (and tool driver 156 if included) travels back up mast 150 so that another foundation component may be loaded before moving mast 150 in the opposing direction to drive the adjacent foundation component so that the pair straddles the intended North-South line of the tracker row and points at a common work point.

When machine 100 is driving the foundation component to embed it into the ground according to one or more installation parameters, a prediction as to whether that foundation component has been embedded into the ground with sufficient resistance to pullout can be rendered. Namely, as machine 100 is driving the foundation component to embed it into the ground according to one or more installation parameters, as will be described further herein, machine 100 can input substantially real-time rotary driver 154 related data into a predictive foundation embedment module. This predictive foundation embedment module can use this substantially real-time rotary driver related data along with one or more past foundation embedment data correlations to predict whether the foundation component has been embedded by the machine into the ground to provide sufficient resistance to pull out of that foundation component. For instance, the one or more past foundation embedment data correlations can relate to one or more different and prior foundation component embedments, such as relating to one or more prior, different foundation component embedments at a different installation location. This predictive foundation embedment module can leverage rotary driver data correlations between such one or more different and prior foundation component embedments and the present foundation component embedment to predict, based on the magnitude of correlation, whether the present foundation component has been embedded to provide sufficient resistance to pullout at that location where it has been presently driven.

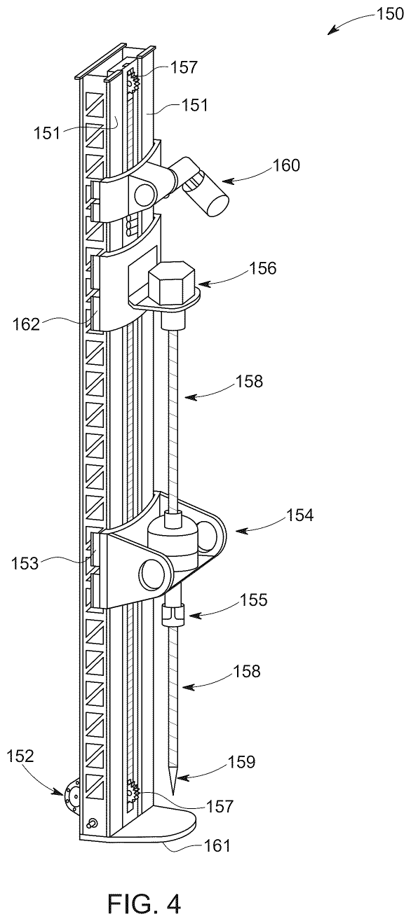

FIG. 4 is an isolation view of the mast 150 and attached components of the embodiment of the foundation component driving machine 100 in greater detail. Mast 150 is formed from elongated sections of steel that are welded together along the seams to form a structure with a generally box-shaped cross-section. Planar portions on opposing side edges of the outer face of mast 150 form tracks 151 running substantially the entire length of mast 151. In this exemplary system, lower crowd motor 152 is mounted near the base of mast 150 on the back side. In various embodiments, lower crowd motor 152 powers a drive train including heavy-duty single or multi-link chain 170 that runs substantially the entire length of mast 150 between a pair of chain tensioners 157 positioned at the top and bottom ends of mast 150. Lower carriage 153 is mounted on tracks 151 and is connected to chain 170 so that when lower crowd motor 152 pulls down on chain 170, carriage 153 causes rotary driver 154 to push down on the head of the attached foundation component 10 (e.g., screw anchor) with the same force. As shown, rotary driver 154 is attached to lower carriage 153 so that the two move together. Rotary driver 154 includes chuck 155 on its lower portion that receives the head of a foundation component (e.g., a head of a screw anchor) and imparts torque and downforce to the head to drive it into the underlying ground. Upper carriage 162 is also tracked on mast 150 and attached to chain 170 driven by lower crowd motor 152. As shown, tool driver 156, in this example, a hydraulic drifter, is attached to upper carriage 162. Hydraulic drifters are often employed in rock drilling machines to provide a selectable combination of rotation and hammering depending on the type of bit used. Herein, the word “tip” in reference to element 159 is used generically to refer to the tool attached to the end of shaft 158 controlled by tool driver 156 and may be a drill bit (button, drag, cross, tri-cone, etc.), a pointed mandrel tip, or other suitable tool. As shown, tip 159 is controlled by tool driver 156 via a shaft 158 connected to the output of tool driver 156 and extending lengthwise down mast 150, through an opening in rotary driver 154 and out through chuck 155. With this configuration, tool driver 156 may impart torque and hammering force to tip 159 through rotary driver 154 and attached screw anchor 10 while rotary driver 154 is driving the screw anchor. Though other embodiments of the machine 100 may not include the tool driver 156.

With the configuration shown in FIG. 4, there are several components that can be individually controlled to effect a driving operation. For example, actuating lower crowd motor 152 will begin to pull lower carriage 153 and in turn rotary driver 154 towards the ground, supplying downforce to foundation component 10 through the rotary driver 154. At substantially the same time, rotary driver 154 may be actuated to begin applying torque to the head of foundation component 10. In various embodiments, it may be advantageous to start the driving operation by applying mostly downward pressure with lower crowd motor 152 because the top layer of soil is usually not structured enough to allow rotation to pull the screw anchor down without simply augering (i.e., drilling) the soil. Therefore, in various embodiments lower crowd motor 152 may be controlled to at least initially lead the driving operation while rotary driver 154 is controlled to rotate at a speed that advances foundation component 10 at the same rate as crowd motor 152. In other words, if the crowd motor is pulling down at the rate of one meter per minute, and the pitch of the screw anchor threads is 0.2 meters (e.g., one revolution results in 0.2 meters of embedment), then the rotary driver may be operated at 5 revolutions per minute to keep pace with the rate of embedment attributable to the lower crowd motor. In practical application, at certain points during the driving operation, there may be reasons for operating the rotary driver slightly faster that this but mismatches between the rotary driver's rate of advance and the rate of advanced resulting from lower crowd motor 152 should be kept small. Even a 5% mismatch may result in augering or coring of soil. Moreover, this or other rotary driver related data can be used to discern a length to which foundation component 10 has been embedded in the ground and, using the predetermined length of the foundation component, thereby discern a remaining length of foundation component available for further embedment into the underlying ground.

As shown, machine 100 can include a series of manual hydraulic controls in a manual control panel as shown in FIG. 3A. These controls may allow manual control of the machine tracks as well the mast, the rotary driver, tool driver, lower crowd motor, and/or upper crowd motor. Notwithstanding these manual controls, maximum accuracy and driving throughput may in many cases be possible by relying only on machine automation. To that end, in various embodiments, machine 100 and mast 150 of FIGS. 3A and 4 may include one or more programmable logic controllers (PLCs) executing a control program that controls the driving functions of machine 100 and mast 150 and that uses real-time sensor data along with stored program code to control of the lower crowd motor, rotary driver, tool driver and/or upper crowd motor to execute a foundation component embedment according to input installation parameters (e.g., depth of embedment, angle of drive axis, etc.)

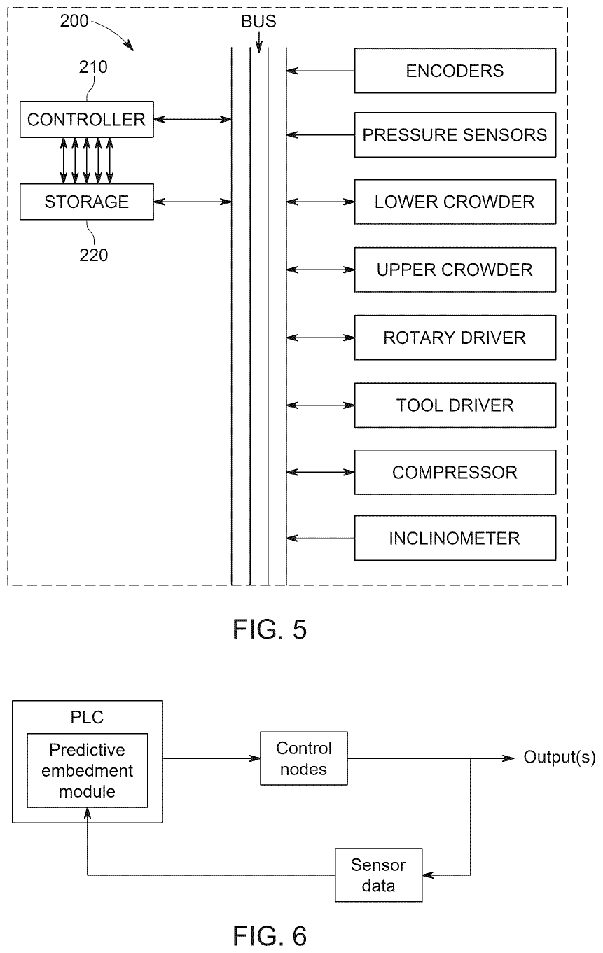

FIG. 5 shows one exemplary configuration of a control circuit that may be used to predict whether a foundation component has been embedded into underlying ground to provide sufficient resistance to pullout of that foundation component. This control circuit can both execute a foundation component embedment according to programmed installation parameters and render a predication as to whether that foundation component embedment will provide sufficient resistance to pullout. To render to prediction as to whether the foundation component being driven into the ground has been embedded to provide sufficient resistance to pullout, the control circuit shown at FIG. 5 can use controller 210 to acquire substantially real-time rotary driver 154 related data (e.g., from pressure sensor(s) in the case of a hydraulic rotary driver; from electrical current sensor(s) in the case of an electrically driven rotary driver) and input this substantially real-time rotary driver 154 related data into a predictive embedment module stored at storage 220 and executed by controller 210. This stored predictive foundation embedment module can be executed by the controller 210 to use this substantially real-time rotary driver related data along with one or more past foundation embedment data correlations to predict whether the foundation component has been embedded by the machine into the ground to provide sufficient resistance to pull out. This can be repeated at subsequent times at other locations where other foundation anchor components are to be embedded in the ground and can, thereby, enable more efficient flagging and remediation of potentially problematic embedded foundation components (e.g., potentially capable of being pulled out from the ground at a predetermined pull out force magnitude).

The control circuit 200 includes the PLC labeled controller 210 at FIG. 5. The PLC may be an off-the-shelf black-box device from Rockwell Automation or other supplier or merely a circuit board containing a programmable microprocessor and other necessary components mounted in a box on the machine and controllable via a user interface and/or remote control. Controller 210 may execute program code stored in non-volatile, non-transitory memory, labeled storage 220 at FIG. 5. The program code executed by controller 220 may be written in structured text, instruction list or other suitable IEC 61131-3 textual or graphical programming language standard. As shown, controller 210 is connected to a communication bus that is used to relay sensor data and control signals between the circuit components. The bus may be a wired bus, such as an N-bit communication line, a wireless bus operating on one or more suitable wireless communication protocols (e.g., Wi-Fi, Bluetooth, Zigbee, ZWave, Digi Mesh, 2 G-5 G, etc.), or combinations of wired and wireless protocols. Multiple sensors are shown on control circuit 200 that provide substantially real-time information to controller 210. In this example, these can include encoders (e.g., linear and rotary encoders) used to incrementally count the movement of moving objects with respect to a non-moving reference, pressure sensor(s) for measuring hydraulic pressure (or in the case of an electrically powered rotary driver, current sensor(s) for measuring current across the electric rotary drive motor), downforce, air pressure, and/or resistance, among other variables. The sensors may also include one or more inclinometers used to facilitate self-leveling adjustment prior to driving, to determine the extent of roll adjustment needed to self-level, and also to monitor changes in level that occur during driving as the mast and machine lift-up in response to driving resistance. In some situations, it may be necessary to calculate the extent of such movement for the purpose of recalculating the embedment depth based on the machine's new position. Because such movement changes the location of reference locations on the mast relative to their location before driving started, linear and rotary encoders will not detect this type of movement, resulting in a failure to achieve the desired driving depth. Controller 210 may also receive real-time state information from lower crowd motor 152, upper crowd motor 160, rotary driver 154, tool driver 156, air compressor (not shown), and/or a hydraulic control system (not shown) and may send commands to these components as part of the automated control program for driving foundation components (e.g., screw anchors). This could include output torque, rate of rotation, rate of travel, etc. The direction of the arrows shown in control circuit 200 can indicate the direction of information flow. Controllable nodes (e.g., upper crowd, lower crowd, etc.) have two-way arrows while sensors merely transmit information and therefore are connected with one-way arrows. Though not shown here, a separate power bus may supply power and/or hydraulic pressure to one or more of the nodes.

As noted, controller 210 can use substantially real-time rotary driver related data, such as real-time state information from one or both of encoder(s) and pressure sensor(s) (or current sensor(s) in the case of an electrically powered rotary driver) and input this substantially real-time rotary driver related data into a predictive embedment module stored at storage 220 and executed by controller 210. This stored predictive foundation embedment module can be executed by the controller 210 to use the substantially real-time rotary driver related data along with one or more past foundation embedment data correlations to predict whether the foundation component has been embedded by the machine into the ground to provide sufficient resistance to pull out. The storage 220 may also contain other information generated during one or more driving operations. In various embodiments, it may be desirable to store acquired data remotely (e.g., in a cloud-based database) because it may be useful to have this information stored with other information about the job site that is not necessary for operation of the driver control system. Therefore, the circuit may store this information temporarily and transfer it to available cloud-storage via the bus when in proximity to a network or via a USB port or SD card. Alternatively, a smartphone application or other external device may be used to initiate transfer of this data. In various embodiments, stored information may include information corresponding to a solar tracker foundation installation job, such as, for example a single-axis tracker, including high level information about a job including job owner, system operator, location, maps/images, the type of system, size of the system, components of the system and job plans. Stored information may also include information generated during driving operations including the specific location where foundation components were driven, sensor data received during the driving operation, and/or control signals send to controllable nodes (e.g., lower crowder, upper crowder, rotary driver, tool driver, etc.).

FIG. 6 is a block diagram showing an exemplary control system. The feedback control loop shown for the control system at FIG. 6 can be a virtual structure formed from programmable logic controller (PLC) that executes a control program sending information to control nodes and receiving information from sensors connected to the output of the control nodes. Therefore, the components shown at FIG. 6 can be distributed on the machine and connected by information flows. Portions may be implemented as a computer, a circuit board, an application specific integrated computer (ASIC), firmware or a combination of hardware and software. Portions may reside in a standalone enclosure communicatively coupled to the control nodes by physical connection or via one or more wireless communication links.

For some specific such examples, the control system as shown at FIG. 6 can be a closed-loop feedback control system. Generally speaking, sensor data from the output is monitored in real-time and that data is compared to the current set point. If necessary, adjustments are made to the inputs to achieve the current setpoint. In the context of the present disclosure, the inputs are supplied to the control nodes to impact the foundation anchor component driving process. The inputs could be instructions from a user interface (e.g., initiate a screw anchor driving process) or lower level inputs like control signals from a controller to an actuator to cause the actuator to perform a process step in the screw anchor driving process (e.g., power the lower crowd motor to provide a specific amount of force, power the rotary driver to spin at a specific rate, etc.). Sensors capture output parameters (e.g., rate of penetration, rotational speed, pressure/current, etc.) and that information may be communicated back to the PLC or controller so that it can determine if the output is consistent with the set point. If not, the PLC may adjust an input to one or more of the control nodes to achieve the desired setpoint.

In the context of the screw anchor driving machine according to the various embodiments of the invention, the tool driver may communicate the real-time magnitude of the downward force it is exerting on the drive train and/or the rotary driver, the amount of resistance force it is experiencing, and/or the frequency and force of hammering by the tool driver. Similarly, the rotary driver may communicate its real time speed of rotation, direction of rotation, rotary pressure (or current), and/or rate of advance. The PLC may store one or more tables of optimal operating parameters or ranges of parameters corresponding to various, different subsurface soil conditions. The PLC can store such tables in non-volatile memory and issue commands to control nodes (e.g., rotary driver) to execute and maintain performance according to the foundation installation parameter(s). The PLC may also store this information corresponding to the driving process for each foundation anchor component in association with a location (e.g., global positioning system coordinate location) and/or other identifier for that foundation anchor component. This information can be useful post-installation for the project developer, financier, geotechnical engineer or other interested party for future embedment iterations or other purposes.

The control system illustrated at FIG. 6 can be executed to predict whether a driven foundation component has been sufficiently embedded in the ground according to various embodiments of the invention. For instance, this control system can be implemented at the machine for driving foundation component(s) described elsewhere herein. The control system illustrated at exemplary FIG. 6 can input substantially real-time rotary driver related data into the predictive embedment module executed by the PLC. This stored predictive foundation embedment module can be executed by the PLC to use this substantially real-time rotary driver related data along with one or more past foundation embedment data correlations to predict whether the foundation component has been embedded by the machine into the ground to provide sufficient resistance to pull out.

In particular, as shown at FIG. 6, the control system can measure sensor data at one or more machine control nodes, and this measured sensor data at the machine during foundation component embedment can be input to the PLC and used by the PLC to execute the predictive embedment module. For example, the control system can measure substantially real-time rotary driver torque related data while the rotary driver is driving the foundation component unto underlying ground, and this measured substantially real-time rotary driver torque related data can be input to the PLC and used by the PLC to execute the predictive embedment module. In one more specific such example where a hydraulically-actuated rotary driver is used to embed the foundation component, the control system can measure one or more substantially real-time pressure measurements across the hydraulically-actuated rotary driver while the hydraulically-actuated rotary driver is driving the foundation component unto underlying ground, and this measured one or more substantially real-time pressure measurements across the hydraulically-actuated rotary driver can be input to the PLC and used by the PLC to execute the predictive embedment module. In another specific such example where an electrically-actuated rotary driver is used to embed the foundation component, the control system can measure one or more substantially real-time electrical current measurements across the electrically-actuated rotary driver while the electrically-actuated rotary driver is driving the foundation component unto underlying ground, and this measured one or more substantially real-time electrical current measurements across the electrically-actuated rotary driver can be input to the PLC and used by the PLC to execute the predictive embedment module. Additionally or alternative, the control system can measure substantially real-time encoder(s) data representing rotary driver position while the rotary driver is driving the foundation component unto underlying ground, and this measured substantially real-time rotary driver position data can be input to the PLC and used by the PLC when executing the predictive embedment module and/or when taking a remediation action in response to execution of the predictive embedment module.

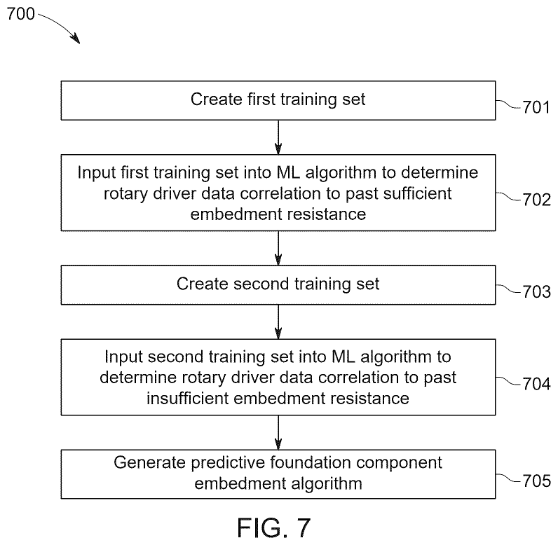

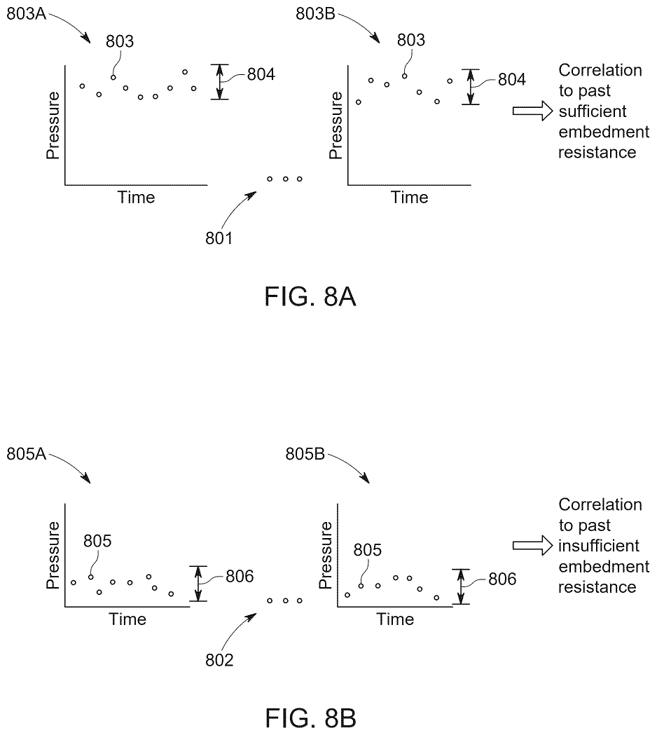

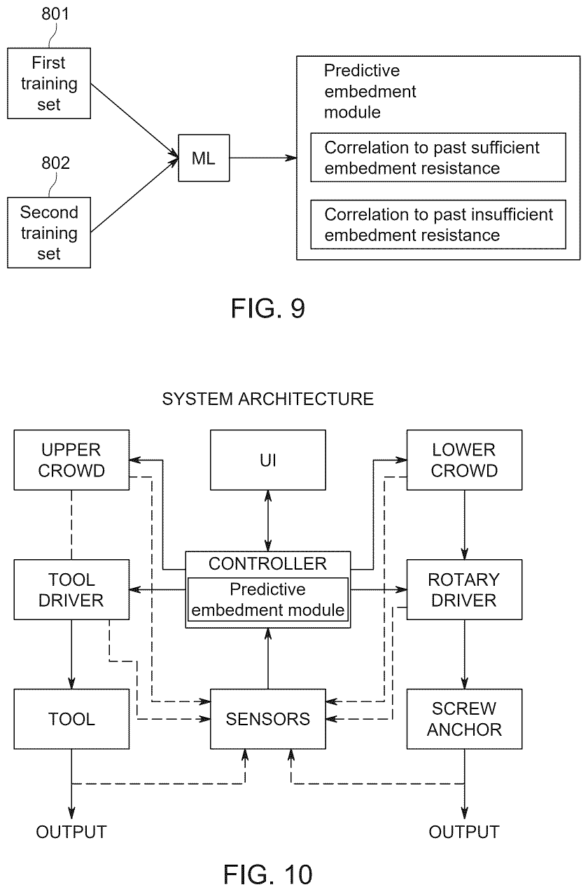

To render a predication as to whether the foundation component has been embedded into the ground to provide sufficient resistance to pull out, the predictive embedment module can execute a predictive foundation component embedment algorithm that is derived from a machine learning model. FIGS. 7-9 will be referenced as follows to describe exemplary aspects of deriving the predictive foundation component embedment algorithm from a machine learning model. In particular, FIG. 7 is a flow diagram showing exemplary steps of a method 700 for generating this predictive foundation component embedment algorithm according to various embodiments of the invention. To derive this predictive foundation component embedment algorithm, a machine learning model can use training data sets to determine correlations to past sufficient (e.g., sufficient resistance to pullout of the presently embedded foundation component) and insufficient foundation component embedments (e.g., insufficient resistance to pullout of the presently embedded foundation component). FIGS. 8A and 8B show schematic diagram illustrating exemplary such use of training data sets to determine correlations to past sufficient (e.g., FIG. 8A) and insufficient (e.g., FIG. 8B) foundation component embedments according to various embodiments of the invention. And these determined correlations to past sufficient and insufficient foundation component embedments can be used by the predictive embedment module to render a prediction as to whether the presently embedded foundation component has been embedded with sufficient resistance to pullout. FIG. 9 is a block diagram illustrating such use of training data sets and a machine learning algorithm to generate the predictive foundation component embedment algorithm that includes correlations to past sufficient and insufficient foundation component embedments according to various embodiments of the invention.

The method 700 shown at FIG. 7 can be executed to generate the predictive foundation component embedment algorithm of the predictive embedment module by training a machine learning component (e.g., algorithmic model) with pre-existing foundation installation data. In particular, to generate the predictive foundation component embedment algorithm of the predictive embedment module, the machine learning component can be trained with both: (i) a first set of rotary driver torque related data corresponding to one or more prior foundation component installations determined to provide sufficient embedment resistance to foundation component pull out, and (ii) a second training set of rotary driver torque related data corresponding to one or more prior foundation component installations determined to provide insufficient embedment resistance to foundation component pull out.

At step 701, the method 700 includes creating a first training set. The first training set can be created from past rotary driver torque related data corresponding to one or more prior foundation component installations determined to provide sufficient embedment resistance to foundation component pull out. For embodiments using an electrically actuated rotary driver, the first training set can be created from past rotary driver electrical current measurements across an electric drive motor of the rotary driver corresponding to one or more prior foundation component installations determined to provide sufficient embedment resistance to foundation component pull out. For embodiments using a hydraulically actuated rotary driver, the first training set can be created from past rotary driver fluid pressure measurements across the hydraulic rotary driver corresponding to one or more prior foundation component installations determined to provide sufficient embedment resistance to foundation component pull out.

FIG. 8A illustrates one example of first training set 801 created from past rotary driver fluid pressure measurements 803 across the hydraulic rotary driver corresponding to one or more prior foundation component installations determined to provide sufficient embedment resistance to foundation component pull out. Other embodiments can similarly use measured electrical rotary driver current and/or encoder(s) data. As shown for this example, the past rotary driver fluid pressure measurements 803 across the hydraulic rotary driver of the first training set 801 can correspond at least to both: a first prior foundation component installation 803A determined to provide sufficient embedment resistance to foundation component pull out, and a second prior foundation component installation 803B determined to provide sufficient embedment resistance to foundation component pull out. The first and second prior foundation component installation 803A, 803B can be comprised of individual past rotary driver fluid pressure measurements 803 recorded every N time periods during the first prior foundation component installation 803A and during the second, different past time prior foundation component installation 803B. In another embodiment, the first and second prior foundation component installation 803A, 803B can be an aggregated single pressure measurement metric determined from the plurality of past rotary driver fluid pressure measurements 803 of each of the first and second prior foundation component installation 803A, 803B.

For instance, the first prior foundation component installation 803A can include a plurality of rotary driver fluid pressure measurements 803 corresponding to a first past time at a first foundation installation location, and the second prior foundation component installation 803B can include a plurality of rotary driver fluid pressure measurements 803 corresponding to a second, different past time at a second, different foundation installation location different than the first prior foundation component installation 803A.

At step 702, the method 700 includes inputting the first training set 801 into a machine learning model to determine rotary driver data correlation to one or more past sufficient embedment resistance to pull out. As noted, the first training set 801 can include both: pressure measurements 803 from the first prior foundation component installation 803A determined to provide sufficient embedment resistance to foundation component pull out and pressure measurements 803 from the second prior foundation component installation 803B determined to provide sufficient embedment resistance to foundation component pull out. The rotary driver fluid pressure measurements 803 of the first and second prior foundation component installation 803A, 803B that were previosuly determined to provide sufficient embedment resistance to foundation component pull out can be input into and used by the machine learning component to determine one or more correlations between rotary driver fluid pressure measurements of a present foundation component embedment installation and the rotary driver fluid pressure measurements of the first and second prior foundation component installation 803A, 803B that were previosuly determined to provide sufficient embedment resistance to foundation component pull out. For example, the machine learning component can determine a range 804 of both the rotary driver fluid pressure measurements 803 of the first prior foundation component installation 803A and the rotary driver fluid pressure measurements 803 of the second prior foundation component installation 803B, and the machine learning component can use (e.g., compare) this range 804 as one exemplary means to determine a correlation between prior foundation component installation 803A, 803B that were previosuly determined to provide sufficient embedment resistance to foundation component pull out. For such an example, when the controller later executes the predictive embedment module, the controller could compare this sufficient embedment correlation (e.g., range 804) to the rotary driver fluid pressure measurements of a real-time foundation component embedment installation to predict if the present foundation component embedment installation embedded the foundation component into the underlying ground to provide sufficient embedment resistance to foundation component pull out (e.g., when the rotary driver fluid pressure measurements of a real-time foundation component embedment installation are within a preset magnitude of the range 804).

At step 703, the method 700 includes creating a second training set 802. The second training set 802 can be created from past rotary driver torque related data corresponding to one or more prior foundation component installations determined to provide insufficient embedment resistance to foundation component pull out. For embodiments using an electrically actuated rotary driver, the second training set can be created from past rotary driver electrical current measurements across an electric drive motor of the rotary driver corresponding to one or more prior foundation component installations determined to provide insufficient embedment resistance to foundation component pull out. For embodiments using a hydraulically actuated rotary driver, the second training set can be created from past rotary driver fluid pressure measurements across the hydraulic rotary driver corresponding to one or more prior foundation component installations determined to provide insufficient embedment resistance to foundation component pull out.

FIG. 8B illustrates one example of second training set 802 created from past rotary driver fluid pressure measurements 805 across the hydraulic rotary driver corresponding to one or more prior foundation component installations determined to provide insufficient embedment resistance to foundation component pull out. Other embodiments can similarly use measured electrical rotary driver current and/or encoder(s) data. As shown for this example, the past rotary driver fluid pressure measurements 805 across the hydraulic rotary driver of the second training set 802 can correspond at least to both: a third prior foundation component installation 805A determined to provide insufficient embedment resistance to foundation component pull out, and a fourth prior foundation component installation 805B determined to provide insufficient embedment resistance to foundation component pull out. The third and fourth prior foundation component installation 805A, 805B can be comprised of individual past rotary driver fluid pressure measurements 805 recorded every N time periods during the third prior foundation component installation 805A and during the fourth, different past time prior foundation component installation 805B. In another embodiment, the third and fourth prior foundation component installation 805A, 805B can be an aggregated single pressure measurement metric determined from the plurality of past rotary driver fluid pressure measurements 805 of each of the third and fourth prior foundation component installation 805A, 805B.

For instance, the third prior foundation component installation 805A can include a plurality of rotary driver fluid pressure measurements 805 corresponding to a third past time at a third foundation installation location. The fourth prior foundation component installation 805B can include a plurality of rotary driver fluid pressure measurements 805 corresponding to a fourth, different past time at a fourth, different foundation installation location different than the first, second, and third prior foundation component installation 803A, 804B, 805A.

At step 704, the method 700 includes inputting the second training set 802 into the machine learning model to determine rotary driver data correlation to one or more past insufficient embedment resistance to pull out. As noted, the second training set 802 can include both: pressure measurements 805 from the third prior foundation component installation 805A determined to provide insufficient embedment resistance to foundation component pull out and pressure measurements 805 from the fourth prior foundation component installation 805B determined to provide insufficient embedment resistance to foundation component pull out. The rotary driver fluid pressure measurements 805 of the third and fourth prior foundation component installations 805A, 805B that were previosuly determined to provide insufficient embedment resistance to foundation component pull out can be input into and used by the machine learning component to determine one or more correlations between rotary driver fluid pressure measurements of a present foundation component embedment installation and the rotary driver fluid pressure measurements of the third and fourth prior foundation component installations 805A, 805B that were previosuly determined to provide insufficient embedment resistance to foundation component pull out. For example, the machine learning component can determine a range 806 of both the rotary driver fluid pressure measurements 805 of the third prior foundation component installation 805A and the rotary driver fluid pressure measurements 805 of the fourth prior foundation component installation 805B, and the machine learning component can use (e.g., compare) this range 806 as one exemplary means to determine a correlation between prior foundation component installation 805A, 805B that were previosuly determined to provide insufficient embedment resistance to foundation component pull out. For such an example, when the controller later executes the predictive embedment module, the controller could compare this insufficient embedment correlation (e.g., range 806) to the rotary driver fluid pressure measurements of a real-time foundation component embedment installation to predict if the present foundation component embedment installation embedded the foundation component into the underlying ground to provide sufficient embedment resistance to foundation component pull out (e.g., when the rotary driver fluid pressure measurements of a real-time foundation component embedment installation are within a preset magnitude of the range 804).

At step 705, the method 700 includes generating the predictive foundation component embedment module. According to the examples shown at FIGS. 7-9, the predictive foundation component embedment module can be generated using a machine learning model input with the first and second training sets 801, 802. For example, the machine learning model can use: (i) the input first training set 801 to generate at least one correlation to prior foundation component installations 803A, 803B that were previosuly determined to provide sufficient embedment resistance to foundation component pull out, and (ii) the second input training set 802 to generate at least one one correlation to prior foundation component installations 805A, 805B that were previosuly determined to provide insufficient embedment resistance to foundation component pull out. Each of the machine learning model's (i) generated at least one correlation to prior foundation component installations 803A, 803B that were previosuly determined to provide sufficient embedment resistance to foundation component pull out and (ii) generated at least one correlation to prior foundation component installations 805A, 805B that were previosuly determined to provide insufficient embedment resistance to foundation component pull out can be used to generate the predictive foundation component embedment algorithm of the predictive embedment module. Thus, a programmable controller (e.g., at the foundation driving machine) can execute the predictive embedment module by using both the machine learning component's determined correlation to past sufficient embedments and the machine learning component's determined correlation to past insufficient embedments.

The generated predictive foundation component embedment algorithm of the predictive embedment module can be executed by a controller using substantially real-time rotary driver related data to predict whether a foundation component, corresponding to that substantially real-time rotary driver related data, has been embedded to provide sufficient or insufficient resistance to pullout.

FIG. 10 is a block diagram showing an exemplary control system architecture for a foundation component driving machine according to various embodiments of the invention. The system at FIG. 10 can be, for instance, a more specific implementation of the more generic control system illustrated and described previosuly in reference to FIG. 6. Namely, as shown for example at FIG. 10, substantially real-time rotary driver related data can be input into the predictive embedment module at the foundation component driving machine to predict whether the foundation component has been embedded into underlying ground to provide sufficient resistance to pull out of the foundation component. Notably, this prediction can be rendered by the machine, according to the illustrated exemplary control system architecture, using the predictive embedment module while the machine is present at the location of that foundation component installation corresponding to the input substantially real-time rotary driver related data.

FIG. 10 represents a functional block diagram showing elements of a virtual system to execute a foundation anchor component embedment that includes rendering a prediction as to whether that foundation component being embedded has been embedded into underlying ground to provide sufficient resistance to pull out of the foundation component. For example, the control system at FIG. 10 can perform closed-loop feedback control to drive a foundation anchor component into the ground according to at least one or more foundation installation parameters and in doing so acquire substantially real-time rotary driver related torque data (e.g., rotary driver hydraulic pressure or rotary driver electrical current) that is used to render a predication as to whether that foundation component being embedded has been embedded into underlying ground to provide sufficient resistance to pull out of the foundation component. In the context of the illustration at FIG. 10, virtual designates the fact that these elements are communicatively coupled to form a system but not contained in a single discrete enclosure. In fact, they may be distributed around the machine. In this exemplary architecture a single controller controls all system components and performs feedback control. In practical application there may be two or more controllers. The box labeled controller here may be one or more PLCs, microcontrollers, computers, PC boards, or other known computing device. The controller may receive inputs and send outputs to user interface (“UI”) device. The UI may include a display (e.g., digital touch screen), a set of knobs, dials and buttons (e.g., physical user interface), lights, speakers, and/or other indicators mounted on the machine. Alternatively, the UI may reside on a separate device (e.g., smartphone app, remote control, etc.) and communicate the other system elements via a wired or wireless communication protocol such as Wi-Fi, Bluetooth, ZigBee, 3 G, 4 G, LTE, etc. The user interface can be used to send commands that are translated by the controller into machine language and sent to the various control nodes (e.g., machine, mandrel driver, rotary driver, upper/lower crowd motors, etc.). The user interface can also be used to receive information from the controller such as status information, real-time operating parameters, and alerts.

Among the exemplary elements shown at FIG. 10, the control system can include a rotary driver, a programmable controller, and a storage device (e.g., at the controller). The rotary driver can be controllable to drive a foundation component into underlying ground, and the storage device can store program code for predictive foundation component embedment. The programmable controller can be communicatively coupled to the storage device and the rotary driver. Executing the program code for predictive foundation component embedment can cause the programmable controller to: control the rotatory driver to drive the foundation component into underlying ground, acquire substantially real-time rotary driver related data from the rotary driver while the rotary driver is driving the foundation component into underlying ground, and input the acquired substantially real-time rotary driver related data into the program code for predictive foundation component embedment to predict whether the foundation component has been embedded into underlying ground to provide sufficient resistance to pull out of the foundation component.

For instance, when the program code for predictive foundation component embedment renders a prediction as to insufficient resistance to pull out of the foundation component being embedded, a location (e.g., GPS location) of that foundation component can be saved (e.g., at the storage device or remotely in the cloud). In one such further instance, executing the program code for predictive foundation component embedment can further cause the programmable controller to generate a report indicating that location of the foundation component predicted to have been embedded into underlying ground to provide insufficient resistance to pull out. This can help to target remediation efforts and resources to address structural foundation issues in an efficient manner that can steer resources to the highest return on investment of those resources.

As an additional or alternative example, when the program code for predictive foundation component embedment renders a prediction as to insufficient resistance to pull out of the foundation component being embedded, the program code for predictive foundation component embedment can be executed to cause the programmable controller to determine whether the foundation component has additional length for further embedding the foundation component into the underlying ground at that same location. Then, when the program code for predictive foundation component embedment is executed to cause the programmable controller to determine that the foundation component has additional length for further embedding the foundation component into the underlying ground at that same location, this program code for predictive foundation component embedment can be executed to automatically cause the programmable controller at the machine to further drive the foundation component into the underlying ground.

As noted, the system architecture at FIG. 10 can include the user interface UI. For instance, in some cases, the user interface can be configured to output an indication (e.g., visual indication, audible indication) as to predicted insufficient resistance to pullout corresponding to the foundation component being embedded. In one such example, the controller can use the input substantially real-time rotary driver related data during the embedment of the foundation component at the predictive embedment module to output at the under interface the indication as to predicted insufficient resistance to pullout corresponding to the foundation component being embedded. For instance, the controller can cause the user interface to output an indication as to predicted insufficient resistance to pull out of the foundation component being embedded when the input substantially real-time rotary driver related data during the embedment of the foundation component correlates to past insufficient embedment resistance associated with one or more past and different foundation component embedment installations. This type of indication can be useful in then logging or otherwise flagging that particular foundation component for a potential subsequent remediation action.

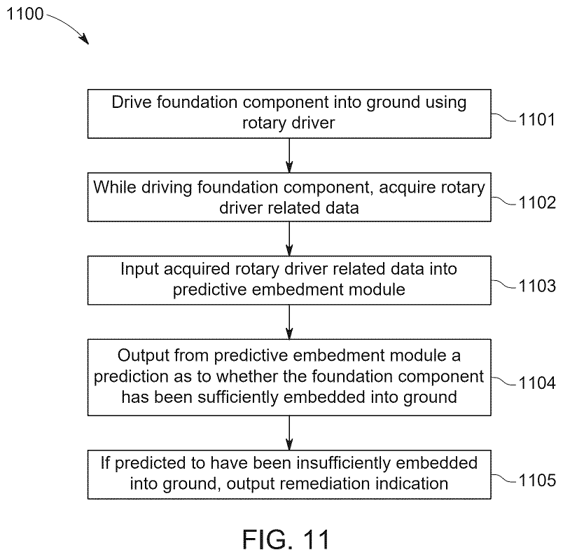

FIG. 11 is a flow diagram showing steps of a method 1100 for predicting adequacy of installation of a solar tracker foundation component according to various embodiments of the invention.

At step 1101, the method 1100 includes driving a foundation component into underlying ground at a first installation location using a rotary driver. As such, step 1101 could include controlling a rotary driver of a foundation component driving machine to embed the foundation component into underlying ground.

At step 1102, the method 1100 includes acquiring substantially real-time rotary driver torque related data from the rotary driver while the rotary driver is driving the foundation component into underlying ground. For example, where the rotary driver is a hydraulically actuated rotary driver, fluid pressure across this rotary driver can be acquired in substantially real-time while the rotary driver is driving the foundation component into underlying ground. As another example, where the rotary driver is an electrically actuated rotary driver, electrical current across this rotary driver can be acquired in substantially real-time while the rotary driver is driving the foundation component into underlying ground.

At step 1103, the method 1100 includes inputting this acquired, substantially real-time rotary driver torque related data into a predictive embedment module. This predictive embedment module can be configured similar to, or the same as, that described elsewhere herein with respect to the predictive embedment module containing each of one or more rotary driver torque related data correlations to past sufficient foundation component embedment resistance and one or more rotary driver torque related data correlations to past insufficient foundation component embedment resistance.

At step 1104, the method 110 includes predicting whether the foundation component has been embedded into underlying ground to provide sufficient resistance to pull out of the foundation component by inputting the acquired substantially real-time rotary driver torque related data into the predictive foundation component embedment module. For example, the predictive embedment module can use one or both of the sufficient correlation and insufficient correlation relating to different, prior foundation component embedments in comparison to the acquired, substantially real-time rotary driver torque related data for the foundation component currently being embedded. If the substantially real-time rotary driver torque related data for the foundation component currently being embedded is determined to more closely correlate to the sufficiently embedded prior foundation component rotary driver torque related data than to the insufficiently embedded prior foundation component rotary driver torque related data, the predictive embedment module can output a predication that the foundation component currently being embedded has been embedded with sufficient resistance to pullout.

At step 1105, if the substantially real-time rotary driver torque related data for the foundation component currently being embedded is determined to more closely correlate to the insufficiently embedded prior foundation component rotary driver torque related data than to the sufficiently embedded prior foundation component rotary driver torque related data, the predictive embedment module can output a predication that the foundation component currently being embedded has been embedded with sufficient resistance to pullout. When the predictive embedment module outputs a predication that the foundation component currently being embedded has been embedded with insufficient resistance to pullout, one or more remediation related actions can occur. For instance, a remediation related output can be provided at the user interface of the machine and/or a location (e.g., GPS location) of that foundation installation location can be saved in association with an indication as to a potential need for a remediation action at that foundation component at that location. For example, a report could be generated indicating the location of the foundation component predicted to have been embedded into underlying ground to provide insufficient resistance to pull out.

The embodiments of the present invention are not to be limited in scope by the specific embodiments described herein. For example, although many of the embodiments disclosed herein have been described with reference to systems and methods for installation of foundation components for single-axis solar trackers, the principles herein are equally applicable to systems and methods for installing foundations for other structures. Indeed, various modifications of the embodiments of the present invention, in addition to those described herein, will be apparent to those of ordinary skill in the art from the foregoing description and accompanying drawings. Thus, such modifications are intended to fall within the scope of the following appended claims. Accordingly, the claims set forth below should be construed in view of the full breath and spirit of the embodiments of the present inventions as disclosed herein.

What is claimed is:

1. A control system for a foundation component installation machine, the control system comprising:
a rotary driver controllable to drive a foundation component into underlying ground;
a storage device storing program code for predictive foundation component embedment; and
a programmable controller communicatively coupled to the storage device and the rotary driver, wherein executing the program code for predictive foundation component embedment causes the programmable controller to:
control the rotatory driver to drive the foundation component into underlying ground,
acquire substantially real-time rotary driver related data from the rotary driver while the rotary driver is driving the foundation component into underlying ground, and
input the acquired substantially real-time rotary driver related data into the program code for predictive foundation component embedment to predict whether the foundation component has been embedded into underlying ground to provide sufficient resistance to pull out of the foundation component.

2. The system of claim 1, wherein the acquired substantially real-time rotary driver related data from the rotary driver comprises substantially real-time rotary driver torque related data while the rotary driver is driving the foundation component into underlying ground.

3. The system of claim 2,
wherein the rotary driver is an electrically actuated rotary driver, and
wherein the acquired substantially real-time rotary driver torque related data comprises at least one electrical current measurement across a drive motor of the rotary driver while the rotary driver is driving the foundation component into underlying ground.

4. The system of claim 2,
wherein the rotary driver is a hydraulically actuated rotary driver,
wherein the acquired substantially real-time rotary driver torque related data comprises at least one fluid pressure measurement across the rotary driver while the rotary driver is driving the foundation component into underlying ground.

5. The system of claim 1,
wherein the program code for predictive foundation component embedment comprises a machine learning code component that has been trained with pre-existing foundation installation data, the pre-existing foundation installation data used to train the machine learning code component comprising:
a first training set of rotary driver torque related data corresponding to one or more prior foundation component installations determined to provide sufficient embedment resistance to foundation component pull out, and
a second training set of rotary driver torque related data corresponding to one or more prior foundation component installations determined to provide insufficient embedment resistance to foundation component pull out.

6. The system of claim 1, wherein, when the acquired substantially real-time rotary driver related data and the program code for predictive foundation component embedment are used to predict that the foundation component has been embedded into underlying ground to provide insufficient resistance to pull out of the foundation component, saving a location of the foundation component.

7. The system of claim 6, wherein executing the program code for predictive foundation component embedment further causes the programmable controller to generate a report indicating the location of the foundation component predicted to have been embedded into underlying ground to provide insufficient resistance to pull out.

8. The system of claim 1,
further comprising a user interface communicatively coupled to the programmable controller,
wherein, when the acquired substantially real-time rotary driver related data and the program code for predictive foundation component embedment are used to predict that the foundation component has been embedded into underlying ground to provide insufficient resistance to pull out of the foundation component, executing the program code for predictive foundation component embedment to cause the programmable controller to output at the user interface an indication as to predicted insufficient resistance to pull out relating to the foundation component.

9. The system of claim 1, wherein, when the acquired substantially real-time rotary driver related data and the program code for predictive foundation component embedment are used to predict that the foundation component has been embedded into underlying ground to provide insufficient resistance to pull out of the foundation component, executing the program code for predictive foundation component embedment to cause the programmable controller to determine whether the foundation component has additional length for further embedding the foundation component into the underlying ground.

10. The system of claim 9, wherein when the program code for predictive foundation component embedment is executed to cause the programmable controller to determine that the foundation component has additional length for further embedding the foundation component into the underlying ground, executing the program code for predictive foundation component embedment to automatically cause the programmable controller to further drive the foundation component into the underlying ground.

11. A machine for driving foundation components comprising:
a base machine;
an adjustable mast attached to the base machine;
a rotary driver movably attached to the mast and controllable to drive a foundation component into underlying ground;
a storage device storing program code for predictive foundation component embedment; and
a programmable controller communicatively coupled at least to the storage device and the rotary driver, wherein executing the program code for predictive foundation component embedment causes the programmable controller to:
control the rotatory driver to drive the foundation component into underlying ground,
acquire substantially real-time rotary driver related data from the rotary driver while the rotary driver is driving the foundation component into underlying ground, and
use the acquired substantially real-time rotary driver related data and the program code for predictive foundation component embedment to predict whether the foundation component has been embedded into underlying ground to provide sufficient resistance to pull out of the foundation component.

12. The machine of claim 11, wherein the acquired substantially real-time rotary driver related data from the rotary driver comprises substantially real-time rotary driver torque related data while the rotary driver is driving the foundation component into underlying ground.

13. The machine of claim 11, wherein the program code for predictive foundation component embedment comprises a machine learning code component that has been trained with pre-existing foundation installation data, the pre-existing foundation installation data used to train the machine learning code component comprising:
a first training set of rotary driver torque related data corresponding to one or more prior foundation component installations determined to provide sufficient embedment resistance to foundation component pull out, and
a second training set of rotary driver torque related data corresponding to one or more prior foundation component installations determined to provide insufficient embedment resistance to foundation component pull out.

14. The machine of claim 11, wherein, when the acquired substantially real-time rotary driver related data and the program code for predictive foundation component embedment are used to predict that the foundation component has been embedded into underlying ground to provide insufficient resistance to pull out of the foundation component, executing the program code for predictive foundation component embedment to cause the programmable controller to save a location of the foundation component.

15. The machine of claim 14, wherein executing the program code for predictive foundation component embedment further causes the programmable controller to generate a report indicating the location of the foundation component predicted to have been embedded into underlying ground to provide insufficient resistance to pull out.

16. The machine of claim 11, further comprising:
a user interface communicatively coupled to the programmable controller,
wherein, when the acquired substantially real-time rotary driver related data and the program code for predictive foundation component embedment are used to predict that the foundation component has been embedded into underlying ground to provide insufficient resistance to pull out of the foundation component, executing the program code for predictive foundation component embedment to cause the programmable controller to output at the user interface an indication as to predicted insufficient resistance to pull out relating to the foundation component.

17. The machine of claim 11, wherein, when the acquired substantially real-time rotary driver related data and the program code for predictive foundation component embedment are used to predict that the foundation component has been embedded into underlying ground to provide insufficient resistance to pull out of the foundation component, executing the program code for predictive foundation component embedment to cause the programmable controller to determine whether the foundation component has additional length for further embedding the foundation component into the underlying ground.

18. The machine of claim 17, wherein the program code for predictive foundation component embedment is executable to automatically cause the programmable controller to further drive the foundation component into the underlying ground based on the determined additional length for further embedding.

19. A method of predicting adequacy of installation of a foundation component, the method comprising the steps of:
controlling a rotary driver of a foundation component driving machine to embed a foundation component into underlying ground;
acquiring substantially real-time rotary driver torque related data from the rotary driver while the rotary driver is driving the foundation component into underlying ground; and
predicting whether the foundation component has been embedded into underlying ground to provide sufficient resistance to pull out of the foundation component by inputting the acquired substantially real-time rotary driver torque related data into program code for predictive foundation component embedment.

20. The method of claim 19, further comprising the steps of:
when the foundation component is predicted to have been embedded into underlying ground to provide insufficient resistance to pull out of the foundation component, saving a location of the foundation component; and
generating a report indicating the location of the foundation component predicted to have been embedded into underlying ground to provide insufficient resistance to pull out.
